(19) United States
(12) Patent Application Publication
(10) Pub. No.: US 2019/0259294 A1
(43) Pub. Date: Aug. 22, 2019

(54) CONTENT DELIVERY SYSTEM FOR INTERACTIVE EDUCATIONAL INSTRUCTION

(71) Applicant: Intervoke, LLC., Denver, CO (US)

(72) Inventors: Tyler Lavern Woods, Evergreen, CO (US); Christine Carol Clevenstine, Evergreen, CO (US)

(73) Assignee: Intervoke, LLC., Denver, CO (US)

(21) Appl. No.: 16/276,763

(22) Filed: Feb. 15, 2019

Related U.S. Application Data
(60) Provisional application No. 62/710,315, filed on Feb. 16, 2018.

(51) Int. Cl. G09B 7/077; G09B 23/28; G09B 7/02; G06T 19/00; G06T 19/20

(52) U.S. Cl. CPC G09B 7/077; G09B 23/28; G06T 19/20; G06T 19/003; G09B 7/02

(57) ABSTRACT

Systems and methods for interactive content delivery are disclosed. In some embodiments, the systems and methods provide an interactive content delivery system for medical instruction, integrating high-fidelity, realistic three-dimensional models of the human anatomy into the curriculum. The interactive content delivery system may operate in any of several instructional modes, selectable by a student user, and may operate on any number of devices with any of several user input mechanisms, such as by touch screen, virtual reality headsets, or augmented reality headsets. The interactive content delivery system may provide testing of a user's learning through any of several testing modes.

### CROSS-REFERENCE TO RELATED APPLICATION

This application is a nonprovisional patent application of and claims the benefit of U.S. Provisional Patent Application No. 62/710,315, filed Feb. 16, 2018 and titled “Content Delivery System for Interactive Educational Instruction,” the disclosure of which is hereby incorporated herein by reference in its entirety.

### FIELD

The present invention is directed to interactive three-dimensional content delivery systems, such as interactive three-dimensional content delivery systems for educational instruction.

### BACKGROUND

Traditional user education approaches typically rely on static and dissimilar instruction materials. A user commonly reviews written instruction materials as a component of a lecture and review cycle, frequently with outside supplemental homework assignments. In some situations, the written instruction materials are supplemented with physical examples or computer models to illuminate portions of the instruction. For example, in medical education, physical models of portions of a human body, such as the heart or the eye, may be provided to present a 3-dimensional perspective to a student. Similarly, a computer-generated image of a body portion, such as the jaw portion, may be present to provide a rudimentary representation of the jaw.

The traditional systems for medical instruction do not provide a comprehensive, integrated instructional experience for the student in that the traditional systems do not provide a complete nor a realistic representation of the human body. The traditional systems also do not effectively or efficiently interact with or integrate with existing lessons plans. Furthermore, the traditional systems do not allow interactive learning by a student or allow learning profiles that may be tuned to a particular student's learning profile.

The disclosure solves one or more of these limitations of the existing systems by providing an interactive three-dimensional (3D) content delivery system (CDS) that rapidly and effectively produces custom educational instruction that satisfies a specific set of curriculum requirements. The custom medical instructions integrate high-fidelity, realistic 3D models of the human anatomy into the particular curriculum.

The disclosed interactive content delivery system may operate in any of several instructional modes, selectable by the student user. For example, the interactive content delivery system may operate in a lecture mode and an interactive mode. Also, the interactive content delivery system may operate on any number of devices with any of several user input mechanisms, such as by touch screen on a tablet or smartphone, or through virtual reality or augmented reality headsets.

Furthermore, the disclosed interactive content delivery system may provide testing of a user's learning through any of several testing modes. For example, the testing modes may comprise an answer mode, a multiple-choice mode, and a drag and drop mode. A user may also be provided analytics and data to facilitate learning, as enabled by a user registering an account with the interactive content delivery system. In some embodiments, a back-end Learning Management System (LMS) is provided which assesses learning comprehension. The LMS may track performance analytics. It will also use an asset management system that allows for dynamic 3D content and online syllabus updates.

The disclosed interactive content delivery system may more rapidly create custom curriculum content by dynamically populating chapter content to build component chapters of instruction. Such an approach allows content to be created in a parallel fashion, rather than by the traditional one-by-one sequential fashion.

Such features of the interactive content delivery system are described in greater detail below.

### SUMMARY

The present disclosure can provide a number of advantages depending on the particular aspect, embodiment, and/or configuration. Generally, the interactive content delivery system disclosed may operate in any of several modes and will provide custom curriculum for instructional learning. The interactive content delivery system may provide high-fidelity, realistic 3D models of one or more portions of the human anatomy, or to enrich the instructional experience. The interactive content delivery system may provide testing and analytics to improve the efficiency and effectiveness of the learning experience.

As briefly discussed above, the disclosed interactive content delivery system may operate in any of several instructional modes, selectable by the student user. For example, the system applications core works off a two-mode system, which allows the user to ingest content in a manner that matches learning style. Because individuals learn differently, the interactive content delivery system (aka the “application”) has been designed so that at any time the user can switch back and forth between Lecture Mode and Interactive Mode to choose the best approach to learn at their own pace.

The disclosed interactive content delivery system may also provide testing of a user's learning through any of several testing modes to judge one's learning comprehension. For example, the testing modes may comprise an answer mode, a multiple-choice mode, and a drag and drop mode. A user may also be provided analytics and data to facilitate learning, as enabled by a user registering an account with the interactive content delivery system. In some embodiments, a back-end Learning Management System is provided which assesses learning comprehension. The interactive content delivery system may allow the user to register an online account so that the system may map analytics and learning data to specific individuals and track progress over time. Learning statements may be sent to a designated LMS or Learning Record Store “LRS” using, for example, the Experience API. “Experience API” or “xAPI” refers to an e-learning software specification. “API” refers to application programming interface. In embodiments that utilize the Experience API, the CDS may readily integrate with a wide variety of LMS or LRS without having to re-author statements for each specific system.

This CDS framework may be either linear 3D (to include interactive and touchscreen), or VR and AR (for a much more immersive environment). A client may either provide medical training content or the system may be designed for the client. The choice of 3D content for operation in “interactivity and lecture modes” (or other modes) may be specifically selected for a particular client.

In one embodiment, a method of delivering interactive educational instruction is disclosed, the method comprising: receiving instructional content; creating a content container; loading the instructional content into the content container; importing one or more 3D models associated with at least a portion of the instructional content; dynamically populating an application; and providing the application to a user.

In one aspect, the method further comprises the step of importing one or more animations associated with at least a portion of the instructional content. In one aspect, the instructional content comprises chapters and quizzes. In one aspect, the instructional content is associated with medical educational content. In one aspect, the application is provided to the user by way of a mobile electronic device. In one aspect, the application is provided to the user by one of a virtual reality interface and an augmented reality interface. In one aspect, the user may interact with the application in at least one of two modes, the two modes comprising a lecture mode and an interactive mode. In one aspect, the application is configured to record testing analytics resulting from user interaction with the application. In one aspect, the application is configured to test a user learning comprehension in at least one of three testing modes, the three testing modes comprising select the answer mode, multiple choice mode, and drag and drop mode. In one aspect, the method further comprises the step of registering a user account. In one aspect, the application comprises a learning management system configured to record testing analytics resulting from user interaction with the application.

In another embodiment, a system to deliver interactive medical educational content to a user is disclosed, the system comprising a computer-readable medium configured to: register a user account; receive medical educational content; create a content container; load the medical educational content into the content container, the medical educational content comprising chapters and quizzes; import a plurality of 3D models associated with at least a portion of the medical educational content; dynamically populate an application; and provide the application to a user.

In one aspect, the user interacts with the application through a touch-screen of an electronic device. In one aspect, the chapters include one or more of text displays, images, voice over audio, and video presentations. In one aspect, the application is provided to the user by one of a virtual reality interface and an augmented reality interface. In one aspect, the step of importing a plurality of animations is associated with at least a portion of the instructional content. In one aspect, the application is configured to present information to the user in at least two different languages.

In yet another embodiment, a non-transitory computer readable medium having stored thereon computer-executable instructions is disclosed, the computer executable instructions causing a processor of a device to execute a method of delivering interactive educational instruction comprising: receiving instructional content; creating a content container; loading the instructional content into the content container; importing 3D models associated with at least a portion of the instructional content; importing one or more animations associated with at least a portion of the instructional content; dynamically populating an application; and providing the application to a user.

In one aspect, the instructional content comprises chapters and quizzes, the chapters including one or more of text displays, images, voice over audio, and video presentations; and the application is provided to the user by one of a virtual reality interface and an augmented reality interface. In one aspect, the application comprises a learning management system configured to record testing analytics resulting from user interaction with the application.

By way of providing additional background, context, and to further satisfy the written description requirements of 35 U.S.C. § 112, the following references are incorporated by reference in their entireties: U.S. Pat. No. 6,083,162 to Vining; U.S. Pat. No. 9,561,088 to Sachdeva; and U.S. Pat. No. 5,412,763 to Knoplioch; and WIPO Patent Appl. No. WO/2016/073792 to Matt.

The word “app” or “application” means a software program that runs as or is hosted by a computer, typically on a portable computer, and includes a software program that accesses web-based tools, APIs and/or data.

The phrase “virtual reality” or “VR” means a computer-generated simulation or representation of a 3D image or environment that may be interacted with in a seemingly real or physical way by a user using specialized electronic equipment, such as a helmet with a screen inside or gloves fitted with sensors.

The phrase “augmented reality” or “AR” means to superimpose computer-generated data, such as an image, sound, or other feature onto a user's view of the real world, thereby providing a composite, supplemented, or augmented view. For example, a web-based computer system may superimpose a 3D model of an artificial heart valve within a field of view of a camera system.

The phrase “user interface” or “UI”, and the phrase “graphical user interface” or “GUI”, means a computer-based display that allows interaction with a user with aid of images or graphics.

The phrase “Learning Management System” or “LMS” is a software application for the administration, documentation, tracking; reporting and delivery of educational courses or training programs. They help the instructor deliver material to the students, administer tests and other assignments, track student progress, and manage record-keeping. LMSs are focused on online learning delivery but support a range of uses, acting as a platform for fully online courses, as well as several hybrid forms, such as blended learning and flipped classrooms. LMSs can be complemented by other learning technologies such as a training management system to manage instructor-led training or a Learning Record Store to store and track learning data.

The phrase “Learning Record Store” or “LRS” is a data store system that serves as a repository for learning records collected from connected systems where learning activities are conducted. It is an essential component in the process flow for using the Experience API standard by ADL or the Caliper standard by IMS Global.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably. The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any storage and/or transmission medium that participate in providing instructions to a processor for execution. Such a computer-readable medium is commonly tangible, non-transitory, and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that can perform the functionality associated with that element.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any storage and/or transmission medium that participate in providing instructions to a processor for execution. Such a computer-readable medium is commonly tangible, non-transitory, and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that can perform the functionality associated with that element.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The disclosure will be readily understood by the following detailed description in conjunction with the accompanying drawings, wherein like reference numerals designate like elements. The elements of the drawings are not necessarily to scale relative to each other. Identical reference numerals have been used, where possible, to designate identical features that are common to the figures.

FIG. 1 shows an overview of a software architecture for a system for interactive content delivery according to embodiments of the present disclosure;

FIG. 2 shows a flow diagram of the chapter presentation process for the interactive content delivery system of FIG. 1, according to embodiments of the present disclosure;

FIG. 3 shows a flow diagram of the content creation process for the interactive content delivery system of FIG. 1, according to embodiments of the present disclosure;

FIG. 4 shows an overview of a particular application of the interactive content delivery system of FIG. 1, the application involving the physiology of the eye, according to embodiments of the present disclosure;

FIG. 5 shows additional detail of the chapter definition portion of FIG. 4, according to embodiments of the present disclosure; and

FIG. 6 shows a flowchart of a method of use for the interactive content delivery system of FIG. 4, according to embodiments of the present disclosure.

It should be understood that the proportions and dimensions (either relative or absolute) of the various features and elements (and collections and groupings thereof) and the boundaries, separations, and positional relationships presented there between, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Systems and methods for interactive content delivery, such as for educational instruction, are disclosed. In particular, interactive content delivery systems and methods for medical educational instruction are disclosed, such systems and methods integrating high-fidelity, realistic 3D models of the human anatomy into the curriculum.

The interactive content delivery system may operate in any of several instructional modes, selectable by the student user, and may operate on any number of devices with any of several user input mechanisms, such as by touch screen, virtual reality headsets, or augmented reality headsets. The interactive content delivery system may provide testing of a user's learning through any of several testing modes.

The disclosed interactive content delivery system may more rapidly create custom curriculum content by building component chapters of instruction by dynamically populating chapter content. Such an approach allows content to be created in a parallel fashion, rather than by the traditional one-by-one sequential fashion.

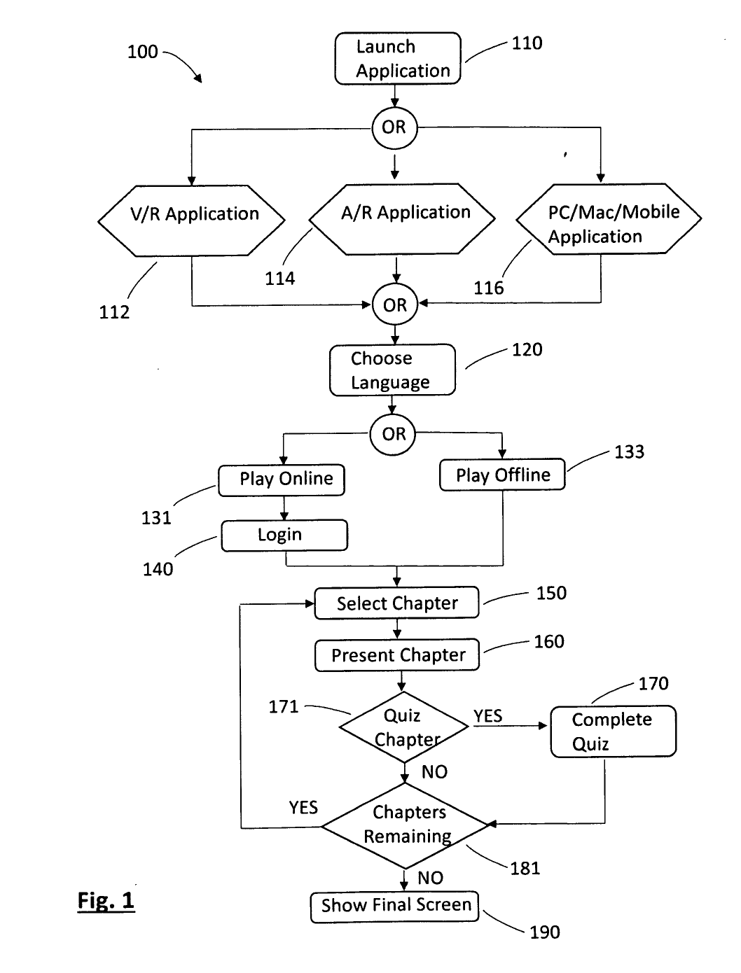

Various embodiments of the system for interactive content delivery (also referenced as simply the “system”) and various embodiments of methods of use of the system for interactive content delivery (also referenced as the “method”) will now be described with respect to FIGS. 1-6.

FIG. 1 shows an overview of a software architecture for a system 100 for interactive content delivery. Generally, the system 100 comprises software modules (aka software elements or software components) of launch application 110, choose language 120, login 140, select chapter 150, present chapter 160, complete quiz 170, and show final screen 190. From a functional perspective, after a particular application is launched (that is, one of 112, 114, 116, as described below), a language is selected (by way of choose language 120) and an option to engage online or offline are entered. Next, selection and presentation of a chapter (of instruction) are executed (by way of select chapter 150), and an optional quiz chapter (at element 171), is executed.

Note that the system 100 is hardware agnostic. Stated another way, the system 100 may be implemented on any number of commercially available hardware platforms, to include PC/Mac, mobile platforms (e.g. iPhone, Android), virtual reality (e.g. Vive, Oculus), and augmented reality (e.g. iPhone, Android, Meta).

The launch application 110 module queries a user to select from one of three applications: a V/R application 112, an A/R application 114, and a PC/Mac/Mobile application 116.

The user is also queried to select a language for instruction by way of the choose language module 120, e.g. English, Chinese, etc. The language selection ensures that the correct text and audio content are used while running the application. Furthermore, a user selects between engaging, or playing, online or offline, by way of play online 131 module and play offline 133 modules, respectively. The application uses an online connection to store activity data and/or test results for a given user. In some embodiments, activity data and/or test results may be provided to a Learning Record Store (LRS) or Learning Management System (LMS). If offline play is chosen, activity data and test results are stored locally on the remotely-running device.

In the event a user selects to play online (by way of element 131), the login module 140 is activated. The login module 140 performs any of several functions. For example, the user may supply an account name and password, wherein such credentials are transmitted to a web server for validation via, for example, HTTP protocol. If the server cannot verify the supplied credentials or the server is offline, then the user will receive an error message. If the user supplies valid credentials, then the user will transition to a table of contents screen where the user may choose a chapter to begin instruction.

The select chapter 150 module populates and presents a table of contents screen, after a user has successfully logged in or selected offline play. A configuration file detailing the number of chapters, chapter titles, and brief descriptions of the content of each chapter, is accessed. The user may select a specific chapter from the table of contents, or the user may start from the beginning with chapter one.

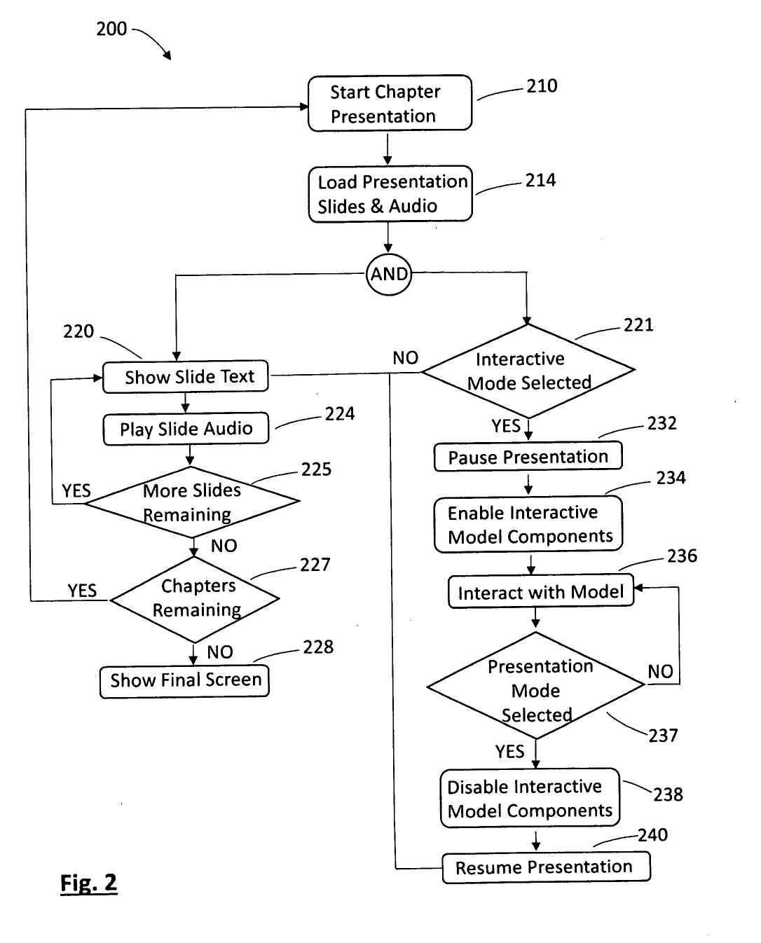

The present chapter 160 module is described in greater detail below with respect to FIG. 2 below.

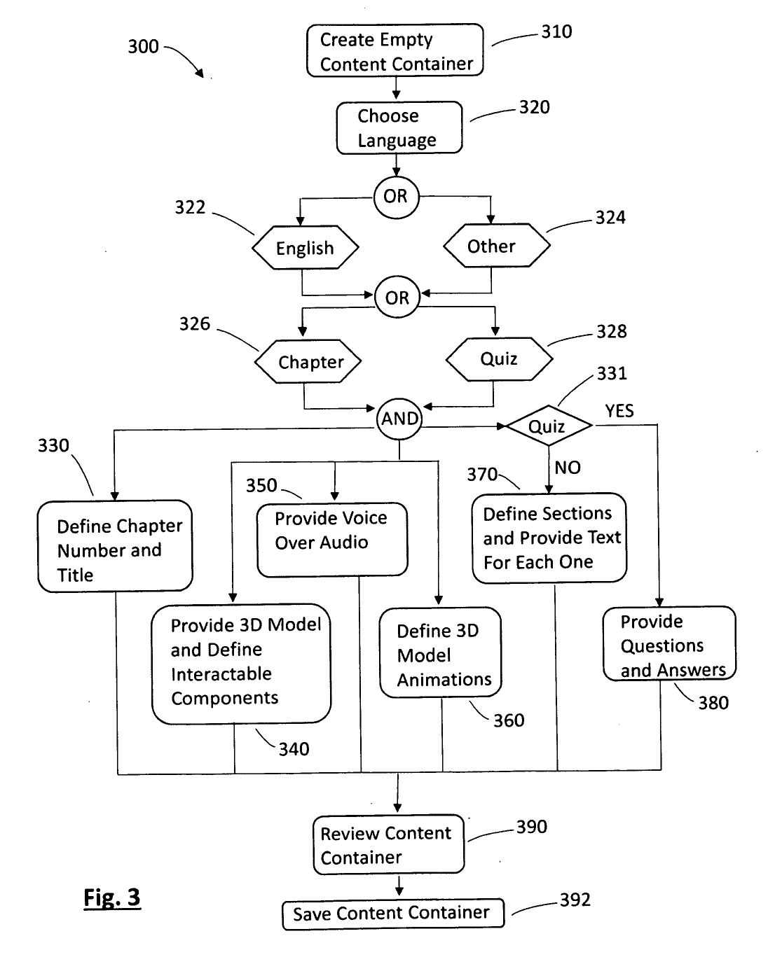

An optional complete quiz module 170 may be engaged by a user, wherein quiz questions regarding the chapter content may be considered. Upon entering the quiz scene, the data is fetched and loaded (See description regarding element 214 in FIG. 2, and description regarding FIG. 3). In one embodiment, once the scene has loaded, the user will have three choices; 1) answer the question, 2) skip the questions and receive an incorrect grade, and 3) quit the quiz and receive an incorrect grade for the remaining questions. When answering a question, the answer may be reviewed and determined as correct or incorrect, and that data will be saved. The location of data storage is determined by user login type, i.e. whether or not the user logged in or is currently offline. Offline users' data will be stored locally on the remote (aka local) device in use; online users who logged in will have data stored on a database, such as an LRS/LMS database for data visualization. Note that when exiting a quiz, the same scenario occurs wherein offline users save data to the remote device and logged in users save data to a database.

When a user has completed all questions of the quiz (as managed by element 170), a user selects to quit the quiz, the quiz ends, and quiz results will be presented. After a user has finished viewing results, the user may continue to another chapter, as new chapters are available (see element 181). That is, additional instructional chapters may be considered at chapters remaining 181 query. If a user completes all chapters or elects to end instruction, the show final screen 190 module is executed. After completing all chapters and quizzes the user may be routed to the final screen that displays results. The results will show each of the questions and whether answered correctly or incorrectly, as well as a GPA across the entire application. Once all the data have been gathered, the data may be displayed in any number of ways, such as on a scrollable window across a table for each quiz, with the GPA on the final screen.

FIG. 2 shows a flow diagram of the chapter presentation process 200 for the interactive content delivery system 100 of FIG. 1. Generally, FIG. 2 provides additional detail as to the present chapter 160 module of FIG. 1.

The start chapter presentation 210 module receives input from a user to begin instruction on a selected chapter. The load presentation slides and audio 214 element loads content associated with the selected chapter. Any previously loaded chapter data are first cleared from the system 100 and replaced with the current chapter's content. The chapter content may include but is not limited to text displays, images, voice over audio, and video presentations. Text information is provided by show slide text 220 module and is displayed in slide format (e.g., similar to Microsoft™ Powerpoint). Play slide audio 224 module presents corresponding voice over audio concurrently with the slide presentation. A presentation will continue in this manner until there are no additional slides to present (as shown by query at module 225), at which point the content for the next chapter will be loaded and displayed. If there are no chapters remaining (as determined by query at module 227), then a final screen is displayed via show final screen 228 module. The final screen may display, e.g., a user's quiz results. (Note that the above description was with regard to operating the system 100 in “lecture mode” aka “presentation mode” rather than “interactive mode.”)

The interactive mode selected 221 query receives input from a user as to switching to interactive mode. Such a switch is available at any point during a chapter presentation. In interactive mode, a user may interact with the displayed model, for example. The chapter presentation may pause the presentation at module 232 and execute the enable interactive model components 234 module and the interact with model 236 module. A user may switch back to presentation mode by way of query module 237. If a user selects to switch to presentation mode from interactive mode (by way of module 237), the disable interactive model components 238 module, and the resume presentation 240 module, are executed.

Note that at load presentation slides & audio 214 module, a specific content container is fetched (see description with respect to FIG. 3 below). Using data from the content container, the system 100 (and the system 200) determines if the current scene is a Chapter or a Quiz, and then proceeds to populate the correct UI with text from the specified content container. In a Quiz, the data populating includes loading the quiz cards with the correct questions. In a Chapter, the data populating includes populating the sidebar with each section of content for that particular chapter. Any remaining data from the container are then loaded into the scene and placed in the correct location; this includes the loading of the 3D assets and the loading of voice over into an Audio Source.

FIG. 3 shows a flow diagram of the content creation process 300 for the interactive content delivery system 100 of FIG. 1.

The creation of a content container to load data into chapters and quizzes begins with the create empty content container 310 module wherein an empty container, which serves as a template for content, is created. A user selects a language for the content via the choose language 320 module. Also, a user selects whether the content to be created is a chapter 326 or a quiz 328.

If the content is for a chapter 326, then a set of five modules (330, 340, 350, 360, and 370) are executed. Specifically, the define chapter number and title 330 module establishes a chapter number, which determines when in the application that particular chapter will appear and the title for the chapter. The module 340 provides a three-dimensional model and defines interactable components. The module 350 provides associated voice over audio. At module 360, three-dimensional models are defined that are compatible with the particular chapter. At module 370, sections within a chapter are defined and text is created for each section.

If the user selects (at element 331) quiz 328 for the content, then at module 380 questions and answers for the quiz are created and provided.

At module 390, the content created (aka imported) for the container is reviewed. The review may include, for example, ensuring that the selectable parts of the model and the animations that particular model will show are interoperable. The content container is saved by way of module 392.

Note that the system 300 allows content containers to be rapidly developed, wherein prototype applications and client demonstrations, for example, may be created much faster than is conventionally possible. The disclosed system and method of content creation, for use in the disclosed content delivery system, dynamically populates content from the containers across the application.

In one embodiment, a collection of internal C# scripts that control all of the 3D content are utilized. This embodiment uses Unity3D and scripts that animate and position all the 3D models and associated information dynamically.

In one embodiment of the content delivery system, application activity data is provided to an LMS/LRS endpoint. A connection to the endpoint is established using a set of credentials prior to any data being sent. The credentials may be supplied by the user or pre-configured within the application using a public key combined with a secret key. A statement is created which details data such as the party that performed the activity, what the activity was, and how the activity was performed. A statement may also include scoring information when pertaining to quiz or test results. A specific API (in one embodiment, an Experience API), is used to generate the statements and to send the statements to LMS/LRS endpoints.

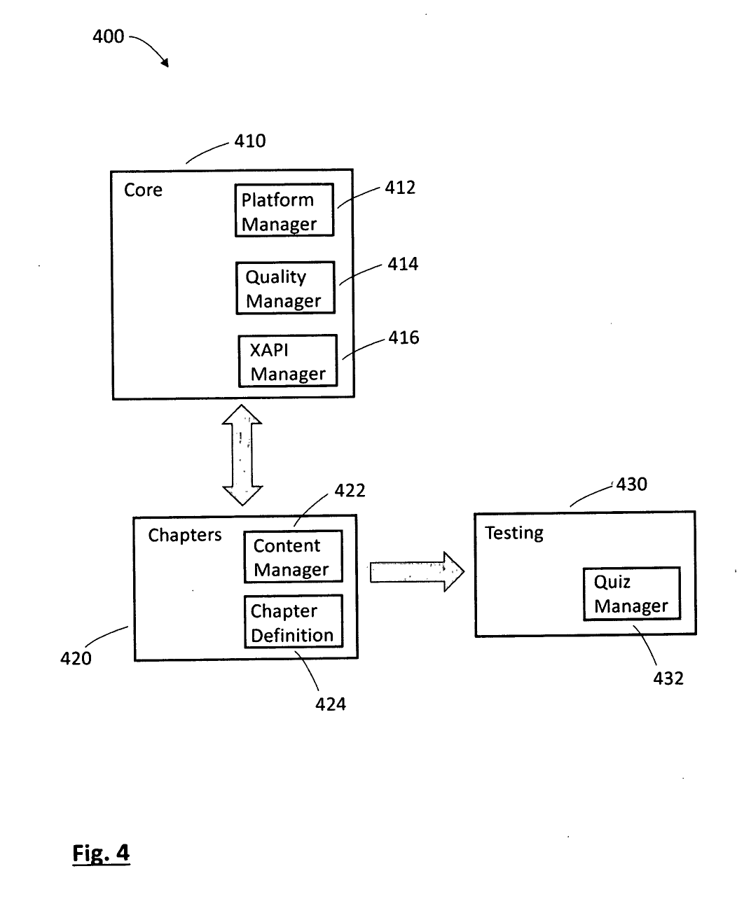

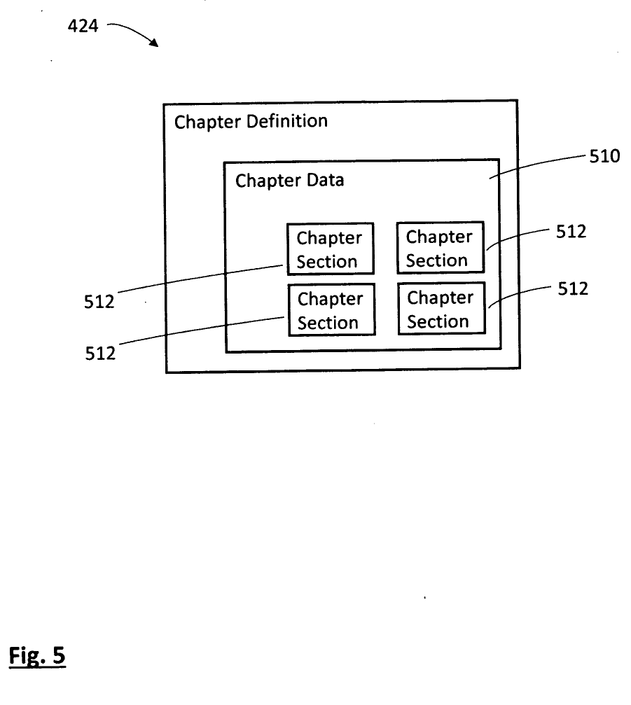

FIGS. 4 and 5 describe a particular application of the interactive content delivery system of FIG. 1, the application involving the physiology of the eye. FIG. 5 provides further details of a particular aspect of FIG. 4. Generally, the application of FIGS. 4-5 is an educational training application designed for mobile devices.

With attention to FIG. 4, an overview of the physiology of the eye (TPOTE) system 400, herein referred to as “TPOTE system” or simply as the “application,” is provided. Generally, the TPOTE system 400 comprises a core module 410, a chapters module 420, and a testing module 430. The core module 410 interacts in a two-way manner with the chapter module 420. The chapter module 420 outputs in a unidirectional manner with the testing module 430.

Note that any or all of the capabilities of the TPOTE system 400 may be applied or used in any of the embodiments of the interactive content delivery system.

The core module 430 is responsible for the entry into the application, unity scene control, system quality settings, and language choice. The core module 410 comprises platform manager 412, quality manager 414, and XAPI manager 416.

The platform manager 412 issues commands for logging into and out of the XAPI manager 416. The platform manager 412 also updates the XAPI manager 416 and manages chapter progression and choice. Furthermore, the platform manager 412 handles scene management and loading. In one embodiment, the platform manager 412 is a singleton. The term “singleton” means a software design pattern that restricts creating object instances such that only one reference of the object exists.

The quality manager 414 sets quality level based on predetermined minspecs. The term “minspec” or the phrase “minimum specifications” means the minimum system hardware or mobile device requirements needed to efficiently run software and may describe minimum and recommended requirements to execute a software system without error. In one embodiment, the quality manager 414 is a singleton.

XAPI manager 416 provides handling connections to the remote LRS, querying LRS data, sending xAPI statements, and the like. In one embodiment, the XAPI manager 416 is a singleton.

The chapters module 420 provides the main content and focus of the application, and where a user spends the majority of time. Chapters mainly consist of data, but also handle several types of input in varying states. In a typical chapter the user will have the ability to, for example: listen to and watch a lesson, pause a lesson, switch between linear and interactive modes during a chapter, and change to any other chapter at any time (as described above with respect to FIG. 2). The chapters module 420 comprises content manager 422 and chapter definition 424.

The content manager 422 serves as the principal director and controller of content in a particular chapter and maintains and organizes objects of the chapter definition 424. Also, the content manager 422 handles two modes during a particular chapter: linear (aka lecture) mode and interactive mode (as previously described with respect to FIG. 2). In one embodiment, the content manager 422 is a singleton.

The chapter definition 424 is a data holder that contains all the data required by the content manager 422 to present a full chapter. The chapter definition 424 module is described in more detail below with respect to FIG. 5.

Note that editing of pre-existing chapters is performed by editing the chapter definition 422 on chapter prefabs, wherein each language has a unique prefab per chapter. The term “prefab” or the phrase “Unity Prefab” refers to a system that allows one to create, configure, and store a GameObject complete with all its components, property values, and child GameObjects as a reusable Unity Asset; the Prefab Asset acts as a template from which one can create new Prefab instances over and over in the Scene and then simply change a subset of settings to make each copied Prefab unique.

Also, note that to add a chapter, one must first create a new empty Game Object and insert a chapter definition script therein. The chapter definition needs to then be filled with the information for the new chapter. Other resources must be created and provided, e.g. the interactive model used during the chapter, the animations, the voice over audio clips, etc. After a new chapter prefab has been created, one will need to select the proper platform manager game object and add the newly created chapter prefab to the proper prefab (e.g. an English Prefab or a Chinese Prefab).

The testing module 430 poses questions and tasks for users to answer and accomplish, the questions and tasks are based on material presented in a chapter. The testing module 430 also presents a result interface wherein a user may evaluate quiz performance. The testing module comprises a quiz manager 432. The quiz manager executes the presenting and answering of quiz questions, as well as the results screen.

The testing module 430 may record and/or track any of the following types of data:
(FOV) Field of View. What the user sees in a virtual world
Time spent on each chapter
Time spent on each section
Time spent on each quiz question
If retaking a quiz, we can show the difference between quiz scores
How many times they have completed a chapter
How many times they selected a part of a model (this could be per model or for all models)
How many times they picked up a 3D model
Total time in the application

Alternatively, or additionally, the above data may be recorded and/or tracked by an LMS in communication with the TPOTE system.

With attention to FIG. 5, additional detail regarding the chapter definition 424 module of FIG. 4 is described. The chapter definition 424 module comprises chapter data 510. The chapter data 510 comprises one or more chapter sections 512. In FIG. 5, the chapter data 510 includes four chapter sections 512.

An example of chapter data 510 are as follows:
Chapter No.: Chapter number Title: Title for this chapter.
Summary: A summary of what content will be gone over in this chapter.
Type: Type of chapter this is with two options: PRESENTATION or QUIZ
Voice Over Clip: Intro/Title soundclip which will be the first audio played upon entering the chapter.
Scene To Load: Which scene to load for this chapter.
Interactive Model: Default model to be used on non-mobile builds.
High Spec Model: Model to be used with high spec quality setting on mobile.
Low Spec Model: Model to be used with low spec quality setting on mobile.
Initial Rotation: Initial rotation for the interactive model in the chapter.
Rotation Point: Name of the GameObject which holds the transform for the desired rotation point of the interactive model.
Highlight Color: NOT USED
Lock Axis: NOT USED
Constraints: NOT USED
Initial Camera Z: Camera distance to the interactive model when the chapter begins.
Depth of Field: Set the camera target by name
Sections[ ]: An array of ChapterSection objects.
Linear Highlights[ ]: NOT USED
Linear Animations[ ]: List of animations to play on the interactive model when entering linear mode.
Linear Mode Camera Offset: Distance to pull the camera when entering linear mode.
Interactive Labels[ ]: List of ChapterHighlight objects which define interactive points of information during interactive mode.
Interactive Highlights[ ]: List of ChapterHighlightObject objects which define the GameObject in the scene and its visibility.
Interactive Animations[ ]: List of animations to play on the interactive model when entering Interactive mode.
Interactive DOF: Set the camera target by name for interactive mode I
Interactive Rotation: Initial rotation for the interactive model when entering interactive mode.
Quiz Questions[ ]: List of QuizQuestion objects which define a question, voice clip and answer.
Quiz Highlights[ ]: List of ChapterHighlightObject objects which define the question answer objects.
Quiz Animations[ ]: List of animations to play on the interactive model when entering Quiz mode.
Quiz Selectables[ ]: NOT USED

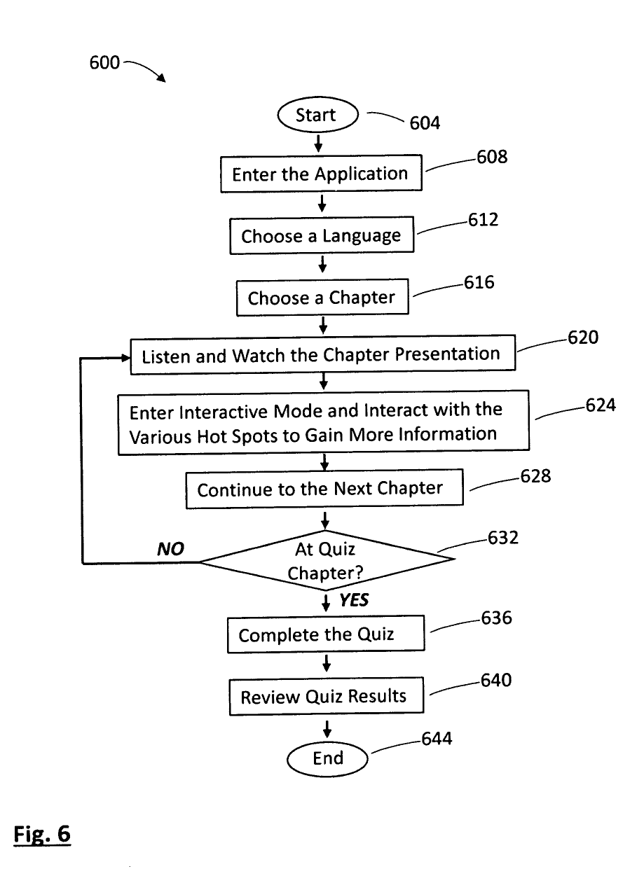

With attention to FIG. 6, a method of use 600 for the interactive content delivery system of FIG. 1 is provided. The flowchart or process diagram of FIG. 6 starts at step 604 and ends at step 644. Some aspects of the method of use 600 will reference elements or components of the above FIGS. 1-5. The steps of method 600 are notionally followed in increasing numerical sequence, although, in some embodiments, some steps may be omitted, some steps added, and the steps may follow other than increasing numerical order.

Generally, the intended goal for a normal user experience when traversing the method 600 is to absorb knowledge from watching and interacting with the presentation in each chapter. A user may switch from linear to interactive mode so as to interact with the presented model, thereby obtaining more information on the material. The user thus acquires the knowledge required to satisfactorily complete a quiz chapter after all other chapters have been completed.

After beginning at step 604, the method 600 proceeds to step 608, wherein the application is entered. Step 608 is similar to the launch application 110 module of FIG. 1. After completion of step 608, the method 600 continues to step 612, wherein a language is selected. Step 612 is similar to the choose language 120 module of FIG. 1. After completion of step 612, the method 600 proceeds to step 616, wherein a chapter is selected. Step 616 is similar to the select chapter 150 module of FIG. 1. After completion of step 616, the method 600 proceeds to step 620.

At step 620, the user listens and watches the selected presentation. Step 620 is generally similar to the activities described above with respect to FIG. 2. After completion of step 620, the method 600 proceeds to step 624, wherein the user may enter interactive mode and interact with targeted areas (aka “hot spots”) to gain additional information and/or understanding. The features of step 624 are similar to the components of interactive mode described with respect to FIG. 2, e.g. elements 232, 234, 236, and 238. After completion of step 624, the method 600 continues to step 628, wherein the user continues to a next chapter. After competing step 624, the user is queried as to if the user is at a quiz chapter. If the reply is No, the method 600 continues to step 620. If the reply is Yes, the method continues to step 636.

At step 636, the quiz is completed. Step 636 is similar to module 170 of FIG. 1. After completing step 636, the method 600 continues to step 640, wherein the quiz results are reviewed. The quiz results may be presented on a final screen, as described in element 190 of FIG. 1 or element 228 of FIG. 2. After completing step 640, the method 600 ends at step 644.

Note that the user, when executing the method 600, has available three principal modes of operation: linear mode, interactive mode, and testing mode. In linear mode, a user may, for example, select a pause button to enter interactive mode, and may select a chapter map to open a chapter selector. In interactive mode, a user may, for example, zoom in and out of the interactive model, select any of several points of interest and interactable models to trigger effects, may select a play button to enter linear mode, and may select a chapter map to open a chapter selector. In test mode, a user may, for example, select various models and buttons to answer questions of a quiz and progress through the quiz.

What is claimed is:

1. A method of delivering interactive educational instruction comprising:
receiving instructional content;
creating a content container;
loading the instructional content into the content container;
importing one or more 3D models associated with at least a portion of the instructional content;
dynamically populating an application; and
providing the application to a user.

2. The method of claim 1, further comprising the step of importing one or more animations associated with at least a portion of the instructional content.

3. The method of claim 1, wherein the instructional content comprises chapters and quizzes.

4. The method of claim 1, wherein the instructional content is associated with medical educational content.

5. The method of claim 1, wherein the application is provided to the user by way of a mobile electronic device.

6. The method of claim 1, wherein the application is provided to the user by one of a virtual reality interface and an augmented reality interface.

7. The method of claim 1, wherein the user may interact with the application in at least one of two modes, the two modes comprising a lecture mode and an interactive mode.

8. The method of claim 1, wherein the application is configured to record testing analytics resulting from user interaction with the application.

9. The method of claim 1, wherein the application is configured to test a user learning comprehension in at least one of three testing modes, the three testing modes comprising select the answer mode, multiple choice mode, and drag and drop mode.

10. The method of claim 1, further comprising the step of registering a user account.

11. The method of claim 1, wherein the application comprises a learning management system configured to record testing analytics resulting from user interaction with the application.

12. A system to deliver interactive medical educational content to a user, the system comprising a computer-readable medium configured to:
register a user account;
receive medical educational content;
create a content container;
load the medical educational content into the content container, the medical educational content comprising chapters and quizzes;
import a plurality of 3D models associated with at least a portion of the medical educational content;
dynamically populate an application; and
provide the application to a user.

13. The system of claim 12, wherein the user interacts with the application through a touch-screen of an electronic device.

14. The system of claim 12, wherein the chapters include one or more of text displays, images, voice over audio, and video presentations.

15. The system of claim 12, wherein the application is provided to the user by one of a virtual reality interface and an augmented reality interface.

16. The system of claim 12, further comprising the step of importing a plurality of animations associated with at least a portion of the instructional content.

17. The system of claim 12, wherein the application is configured to present information to the user in at least two different languages.

18. A non-transitory computer readable medium having stored thereon computer-executable instructions, the computer executable instructions causing a processor of a device to execute a method of delivering interactive educational instruction comprising:
receiving instructional content;
creating a content container;
loading the instructional content into the content container;
importing 3D models associated with at least a portion of the instructional content;
importing one or more animations associated with at least a portion of the instructional content;
dynamically populating an application; and
providing the application to a user.

19. The medium of claim 18, wherein:
the instructional content comprises chapters and quizzes, the chapters including one or more of text displays, images, voice over audio, and video presentations; and
the application is provided to the user by one of a virtual reality interface and an augmented reality interface.

20. The medium of claim 18, wherein the application comprises a learning management system configured to record testing analytics resulting from user interaction with the application.
